(19) United States
(12) Patent Application Publication
(10) Pub. No.: US 2025/0222830 A1
(43) Pub. Date: Jul. 10, 2025

(54) ADJUSTMENT SYSTEM FOR A VEHICLE SEAT, AND METHOD FOR ADJUSTING A VEHICLE SEAT

(71) Applicant: BROSE FAHRZEUGTEILE SE & CO. KOMMANDITGESELLSCHAFT, COBURG, Coburg (DE)

(72) Inventors: Andreas GEISSLER, Kulmbach (DE); Gregor KRÖNER, Bischberg (DE)

(21) Appl. No.: 18/845,225

(22) PCT Filed: Feb. 28, 2023
(86) PCT No.: PCT/EP2023/054948

§ 371 Date: Sep. 9, 2024

(30) Foreign Application Priority Data
Mar. 10, 2022 (DE) 10 2022 202 434.6

(51) Int. Cl. B60N 2/02; B60R 16/033

(52) U.S. Cl. CPC B60N 2/02246; B60R 16/033

(57) ABSTRACT

It is provided an adjustment system for a vehicle seat, having at least one electronically controllable adjustment device for the motorized adjustment of an adjustment position of the vehicle seat, at least one chargeable energy storage device, which is electrically connected to the at least one adjustment device and is configured to provide an operating current for operating the at least one adjustment device, and a charging device, which is connected or connectable to the at least one energy storage device and is connectable to an energy source to charge the at least one energy storage device and is configured to provide a charging current, wherein an amperage of the operating current is greater than a maximum amperage of the charging current.

### CROSS REFERENCE TO RELATED APPLICATIONS

The present application is a U.S. National Phase of International Application No. PCT/EP2023/054948 entitled “ADJUSTMENT SYSTEM FOR A VEHICLE SEAT, AND METHOD FOR ADJUSTING A VEHICLE SEAT,” and filed on Feb. 28, 2023. International Application No. PCT/EP2023/054948 claims priority to German Patent Application No. 10 2022 202 434.6 filed on Mar. 10, 2022. The entire contents of each of the above-listed applications are hereby incorporated by reference for all purposes.

### BACKGROUND

The proposed solution relates to an adjustment system for a vehicle seat and a method for adjusting a vehicle seat. Vehicle seats can be adjustable in a power-operated manner within a vehicle interior via such adjustment systems and/or methods. As an example, vehicle seats can be adjustable in a power-operated manner in a vehicle vertical direction pointing from a vehicle bottom in the direction of a vehicle roof or along a vehicle longitudinal axis.

Both such adjustment systems and such methods for vehicle seats are known in principle from the field of vehicle construction. For the power-operated adjustment, such adjustment systems have electronically controllable adjustment devices, such as electric motors. An operating current has to be provided to actuate such an adjustment device. The adjustment systems comprise an electrical connection for this purpose, via which the adjustment systems are connectable to an energy source, in particular a vehicle electrical system of a vehicle. In particular, such an electrical connection has to be designed here for an amperage of the operating current occurring in operation of the adjustment device.

Especially with regard to modern vehicle concepts, in particular with regard to autonomously driving vehicles, an elevated level of flexibility of an arrangement of vehicle seats in the vehicle interior is desired. It is therefore desirable to equip vehicle seats with adjustment systems which enable an adjustment of an adjustment position along the vehicle longitudinal axis and/or a vehicle transverse axis. In this case, the electrical connection of the energy source to the adjustment device of the vehicle seat has to be configured to permit a corresponding displacement of the vehicle seat within the vehicle interior. As an example, sections of the electrical connection extending between a vehicle bottom and the vehicle seat can be made flexible with the aid of bearing devices, such as drag chains and/or cable cassettes, and at the same time can be protected from mechanical influences. In the case of longer adjustment travels, such bearing devices and also long wiring harnesses can be connected to a not insignificant material expenditure, installation expenditure, and weight.

### SUMMARY

The need therefore exists to further improve adjustment systems for vehicle seats.

This object is achieved by an adjustment system having features as described herein and a method having features as described herein.

The proposed adjustment system for a vehicle seat accordingly comprises:
at least one electronically controllable adjustment device for the motorized adjustment of an adjustment position of the vehicle seat,
at least one chargeable energy storage device, which is electrically connected to the at least one adjustment device and is configured to provide an operating current for operating the at least one adjustment device, and
a charging device, which is connected to the at least one energy storage device and is connectable to an energy source to charge the at least one energy storage device and is configured to provide a charging current, wherein an amperage of the operating current is greater than a maximum amperage of the charging current.

Due to the provision of the at least one energy storage device, the at least one adjustment device can be operated via the energy storage device while the energy storage device is connectable as needed to an energy source and rechargeable. The charging current occurring during the charging has a lower maximum amperage here than the amperage of the operating current. The charging device can accordingly be designed for a lower amperage than a connection of the at least one energy storage device to the at least one adjustment device. Since moreover the at least one energy storage device and the at least one adjustment device are arranged in the intended installed state on the vehicle seat, a cable length necessary for connecting the at least one energy storage device to the at least one adjustment device can be shorter than a cable length of the charging device. Only the connection between the at least one energy storage device and the at least one adjustment device has to be designed here for the operating current occurring in operation. In contrast, the charging device can be designed for a lower amperage than that of the operating current, in particular only for a maximum amperage of the charging current occurring in operation. This can reduce a number of required cables and/or a diameter of the cable used for the charging device. In this way, material expenditure, production costs, and weight can be reducible.

Furthermore, via the proposed adjustment system, the at least one adjustment device can be at least temporarily operational independently of a supply by the energy source. A vehicle seat equipped with the adjustment system can therefore be adjustable in a power-operated manner even if the energy source, such as a vehicle electrical system of a vehicle, is temporarily not available. This can increase a level of usage convenience and a level of safety.

The at least one chargeable energy storage device can be configured to store energy available at a point in time in the form of the charging current in such a way that this energy is retrievable at a later point in time in the form of the operating current. As an example, the at least one chargeable energy storage device can be configured to store energy chemically, mechanically, electrically, thermally, or thermochemically. In particular, the at least one chargeable energy storage device can be designed as an accumulator.

In one exemplary embodiment of the proposed solution, the charging device has a lower current carrying capacity than a connection of the at least one energy storage device to the at least one adjustment device. The material expenditure can be further reducible in this way.

The current carrying capacity of an electrical connection can be definable as a permissible current density. The permissible current density can be definable here as the current density at which critical heating or material degradation of the electrical connection does not take place.

In a further embodiment of the proposed solution, a quotient of the operating current and a minimal conductor cross section of the charging device can be greater than a melting current density of the charging device at the location of the minimal conductor cross section. This can further reduce a material expenditure.

As an example, a melting current density of the charging device can have different values in different sections of the charging device. In particular, the quotient of the operating current and the minimal conductor cross section of the charging device can be greater here than a minimal melting current density of the charging device. Each of the different values of the melting current density can be dependent on a material of the charging device. As an example, the melting current density on at least one of the sections of the charging device can be 3060 A per square millimeter.

Furthermore, as an example, the charging device can be designed having at least one conductor track which comprises an electrically conductive material. Such an electrical material can be copper, for example. In one embodiment, the at least one conductor track of the charging device can be printed onto flexible circuit boards. This can further improve a suitability of the adjustment system for vehicle seats having long adjustment travels.

In a further embodiment of the proposed solution, the charging device can have at least one energy source-side conductor section connectable to an energy source and at least one energy storage device-side conductor section, which is connected to the at least one energy storage device and can be detachably coupled with the at least one energy source-side conductor section, for transmitting electrical energy. This can further improve a suitability of the adjustment system for vehicle seats having broad adjustment travels and further reduce a material expenditure.

In principle, each of the conductor sections can be any type of electrically conductive connection of two points which is configured to conduct a current between the points. As an example, such conductive connections can be formed using cables, in particular copper cables.

The at least one energy source-side conductor section and the at least one energy storage device-side conductor section can be reversibly separable and detachable with one another. The connected or coupled conductor sections can be configured here to conduct the charging current between the energy source connectable to the energy source-side conductor section up to the at least one energy storage device to charge the at least one energy storage device. In contrast, the charging current can be interrupted in the case of the conductor sections which are separated or decoupled from one another.

As an example, the at least one energy source-side conductor section and the at least one energy storage device-side conductor section can be couplable with one another in dependence on a proximity. In this way, the adjustment system can be configured to acquire energy for charging the at least one energy storage device from the energy source in a charging position into which a vehicle seat is adjustable using the adjustment system installed as intended.

As an example, the coupling of the at least one energy source-side conductor section and the at least one energy storage device-side conductor section can be able to be assisted by a magnetic attractive force. As an example, each of the above-mentioned conductor sections can have a magnetic element for this purpose, which is configured to provide an attractive force acting on the at least one energy source-side conductor section and the at least one energy storage device-side conductor section.

In a further embodiment of the proposed solution, each of the conductor sections can have at least one coupling section configured for transmitting and/or receiving electrical energy for coupling the at least one energy source-side conductor section with the at least one energy storage device-side conductor section. This can improve an efficiency of the charging device and a usage convenience.

According to a further embodiment, the adjustment system can enable at least two coupling positions, in each of which a coupling of the energy source-side conductor section with the energy storage device-side conductor section is configured or configurable. For example, the at least two coupling positions can be arranged in series in the longitudinal direction, in particular along an adjustment travel of the vehicle seat. The adjustment system preferably has sufficiently many coupling positions that in each adjustment position of the vehicle seat, in particular in the longitudinal direction of the vehicle, a coupling of the energy source-side conductor section with the energy storage device-side conductor section is configured or configurable. It can be particularly preferable for more conductor sections to be provided for coupling on the energy source side than on the energy storage device side.

In a further embodiment of the proposed solution, at least two of the coupling sections can be arranged spatially separated from one another on one of the at least one energy source-side conductor sections. This can improve a usage convenience and improve a reliability of the adjustment system.

In one exemplary embodiment of the proposed solution, the charging device can have precisely one energy storage device-side conductor section having at least two coupling sections. This can further reduce the material expenditure.

As an example, the vehicle seat having the adjustment system installed as intended can be configured to charge the at least one energy storage device by coupling one of the at least two energy source-side conductor sections with the at least one energy storage device-side conductor section in each of a plurality of different charging positions. As an example, in each of the charging positions, a coupling section of the energy storage device-side conductor section can be coupled with one of the at least two of the coupling sections of the energy source-side conductor section. In this way, the ability to couple the at least one energy source-side conductor section with the at least one energy storage device-side conductor section can be improvable. This can reduce a material expenditure and decrease production costs and a weight of the adjustment system.

In a further exemplary embodiment of the proposed solution, the charging device can have precisely one energy storage device-side conductor section. The proportion of the electrical connections which have to be designed for the operating current occurring in operation of the adjustment device can be reduced in this way. This can further decrease the material expenditure.

In a further exemplary embodiment, the one energy storage device-side conductor section can have precisely one coupling section. The material expenditure can be further reducible in this way.

In a further embodiment of the proposed solution, the one energy storage device-side conductor section can selectively be able to be coupled with one of the at least two coupling sections, which are spatially separated from one another, of the at least one energy source-side conductor section. As an example, a vehicle seat having the adjustment system installed thereon as intended can be configured to charge the at least one energy storage device in a plurality of charging positions, wherein the adjustment system has in each case precisely one energy storage device-side conductor section and precisely one energy source-side conductor section.

In a further embodiment of the proposed solution, at least one of the coupling sections of the at least one energy source-side conductor section and/or the at least one energy storage device-side conductor section can be configured for wireless energy transmission via an electromagnetic field. This can lengthen a service life of the proposed adjustment system and thus reduce a probability of failure.

As an example, the wireless energy transmission between the coupling sections can be formed using inductive energy transmission, resonant inductive energy transmission, capacitive energy transmission, or energy transmission via directed electromagnetic waves.

With regard to an embodiment of the coupling sections for wireless energy transmission using inductive or resonant inductive energy transmission, each of the coupling sections can be formed having at least one coil. Such a coil can comprise an electrical conductor and can be configured to build up a magnetic field by way of a current having a variable amperage. Furthermore, each of the coils can be configured to be permeated by a magnetic field and to induce a current in the conductor of the coil in the case of a magnetic field having a field strength variable over time at the location of the coil.

At least one of the coupling sections can furthermore be formed having a Halbach array of coils. Such a coupling section can accordingly be configured to build up an electromagnetic field essentially along a primary spatial direction, while the individual electromagnetic fields of the individual coils of the Halbach array substantially cancel out on a direction facing away from the primary direction. This can improve a transmission effectiveness.

In an alternative or additional embodiment, the coupling sections for energy transmission can be formed having capacitors.

In a further alternative additional embodiment, at least one of the coupling sections can be designed for transmitting energy via directed electromagnetic waves using a laser and another of the coupling sections can be designed for receiving the directed waves using a photocell. Furthermore, at least one of the coupling sections can be designed for transmitting energy via directed electromagnetic transmission using a directed radio antenna and another of the coupling sections can be designed having an antenna for receiving the waves transmitted by the directed radio antenna.

In one embodiment of the proposed solution, at least one of the coupling sections of the at least one energy source-side conductor section and at least one of the coupling sections of the at least one energy storage device-side conductor section can be detachably electrically conductively connectable to one another. This can further increase an effectiveness of the coupling.

An electrically conductive connection can be any form of a connection in which one of the coupling sections of the energy source-side conductor section and one of the coupling sections of the energy storage device-side conductor section press against one another to transmit electrical energy. In particular, an electrically conductive connection can accordingly be distinguished in that the two coupled coupling sections are connected to one another without air gaps. The electrically conductive connection can in particular be friction-locked and/or formfitting.

In one exemplary embodiment, the at least one coupling section for the detachable electrically conductive connection can have at least one spring-loaded and conductive contact pin for establishing an electrical contact with another of the coupling sections. Due to the loading with a spring force, the conductive contact pin can securely press against the other of the coupling sections and thus ensure a connection without air gaps. This can increase a usage reliability, reduce a wear rate, and avoid undesired sparking.

In a further exemplary embodiment, the at least one contact pin can press against an electrically conductive contact surface of the other of the coupling sections in a coupled state with the other of the coupling sections.

Such contact-based coupling can preferably also be provided for quick charging.

In a further embodiment of the proposed solution, the charging device can have a first energy source-side conductor section having the at least one coupling section for the detachable electrically conductive connection and a second energy source-side conductor section having the at least one coupling section for the wireless energy transmission. As an example, a higher current can be transmittable via the at least one detachable electrically conductive connection from the energy source-side conductor section to the energy storage device-side conductor section than via the coupling sections configured for wireless energy transmission and coupled with one another. This can increase the flexibility of the proposed adjustment system for adaptation to various usage situations.

In one exemplary embodiment, the at least one energy storage device-side conductor section can selectively be able to be coupled with the first or the second energy source-side conductor section. In this way, in operation of the adjustment system installed as intended on a vehicle seat, the at least one energy storage device can selectively be charged via a wireless energy transmission or an electrically conductive connection. A charging current provided via the coupling of the conductor sections can therefore be adapted in operation of the adjustment system installed as intended on the vehicle seat in dependence on an operating situation. As an example, the adjustment system can be arranged on the vehicle system in such a way that the vehicle seat has various charging positions, wherein in at least one of the charging positions, a coupling section of the at least one energy source-side conductor section and a coupling section of the at least one energy storage device-side conductor section are electrically conductively connected. In another charging position, a coupling section of the at least one energy source-side conductor section and a coupling section of the at least one energy storage device-side conductor section can be coupled for wireless energy transmission. Therefore, the vehicle seat can be adjusted between the various charging positions to select whether the charging current is to be provided via the electrically conductive connection or the wireless energy transmission.

In a further embodiment of the proposed solution, the first energy source-side conductor section can have a higher current carrying capacity than the second energy source-side conductor section. In this way, the at least one energy storage device can be chargeable via charging currents of different strengths and the adjustment system can be connectable to an energy source via a plurality of different coupling sections. This can increase the usage convenience.

According to a further embodiment, the adjustment system can be designed so that no redundant power supply of the adjustment device via the charging device and the energy storage device is provided. The wiring required for the power supply can thus be further reduced.

In order to be able to scale the adjustment system easily according to a determined need, the adjustment system can have at least two energy storage devices, which are each electrically connected or connectable to the charging device and the adjustment system can have at least two adjustment devices for the motorized adjustment of an adjustment position of the vehicle seat. The energy storage devices can therefore be designed independently of one another. Preferably, each adjustment device has at least one energy storage device assigned thereto, which is exclusively configured for the power supply of the adjustment device assigned thereto. Number, sizes, capacitances, and/or power classes of the required energy storage devices can therefore be adapted better to the assigned adjustment devices.

It can therefore be provided that the energy storage devices assigned to the different adjustment devices have different power classes.

To be able to achieve optimum charging, charging of one of the at least two energy storage devices via the charging device can be activatable and/or deactivatable independently of another of the at least two energy storage devices. If, for example, only one energy storage device is fully charged, its charging can be interrupted, wherein a further energy storage device is charged further.

In a further embodiment, the adjustment system can have a checking unit, which is configured to check the state of charge of the at least one energy storage device, wherein the checking unit emits a warning signal as soon the state of charge is below a critical state of charge value. In particular, the warning signal can be transmittable to a control unit of a vehicle and/or can be displayable via a display device to a user. It is therefore possible to prevent, for example, the energy that can be provided by an energy storage device no longer being sufficient to be able to perform an adjustment.

According to a further embodiment, a contactless and a contact-based current transmission can be possible via the charging device. In particular, a contactless current transmission can take place in the normal case and a contact-based current transmission can take place in the quick charging case. Charging of the energy storage device performed in the normal case can be provided, for example, during the normal operation of the vehicle. Quick charging can be provided, for example, when the charging device and/or a vehicle are connected to an external charging station. For this purpose, it can be provided that a special quick charging position is approached in order to configure the contact-based current transmission. Quick charging therefore cannot take place in every adjustment position of the vehicle seat.

In a further embodiment, a charging voltage generated by an energy source can be different from an operating voltage required to operate the at least one adjustment device.

According to a specific embodiment, the at least one electronically controllable adjustment device can comprise at least one seat longitudinal adjustment.

In a further embodiment, the charging device can be deactivatable, wherein the at least one electronically controllable adjustment device can be supplied with current independently via the at least one energy storage device when the charging device is deactivated.

To be able to prevent, for example, in an electric vehicle having critical state of charge of an energy source, in particular an energy source also used for supplying a vehicle drive, charging of the at least one energy storage device from taking place, the adjustment system can have a control device which is configured to deactivate charging of the at least one energy storage device if the state of charge of the energy source is below a threshold value. Preferably the control device can be configured to deactivate the charging device as soon as the state of charge of the energy source is below a threshold value.

As an example, the first energy source-side conductor section can have a current carrying capacity for quick charging which is higher than a current carrying capacity of a further energy source-side conductor section, in particular the second energy source-side conductor section. As an example, the further energy source-side conductor section can be designed for a maximum amperage of the charging current which is less than the maximum amperage of the charging current of the first energy source-side conductor section. The first energy source-side conductor section can therefore be configured for quick charging.

As an example, the adjustment system installed as intended on the vehicle seat can be configured to couple the first energy source-side conductor section with the energy storage device-side conductor section or to couple the second energy source-side conductor section with the at least one energy storage device-side conductor section in dependence on the adjustment position of the vehicle seat within the vehicle interior. Therefore, the adjustment system installed as intended on the vehicle seat can be configured to charge the at least one energy storage device with a higher charging current in a quick charging position than in at least one further charging position. This can increase the usage convenience.

In one embodiment of the proposed solution, the quick charging position can be an adjustment position of the vehicle seat arranged between two end positions. Accordingly, the vehicle seat can be adjustable by the at least one adjustment device in a motorized manner along the at least one adjustment direction from one of the end positions to the other of the end positions. During such an adjustment from the one of the end positions to the other of the end positions, the vehicle seat having the proposed adjustment system can pass the quick charging position. In this way, the quick charging position can be arranged adjacent to a usage position which is regularly assumed in the usage of the adjustment system used in a vehicle. This can reduce a length of the adjustment travels required in operation for adjusting the vehicle seat into the quick charging position and can thus increase the usage convenience.

As an example, a capacitance of the at least one energy storage device can be designed for a large number of adjustment cycles. Each adjustment cycle can represent a complete adjustment of the vehicle seat having the at least one adjustment device along an adjustment direction. As an example, an adjustment cycle can comprise an adjustment of the vehicle seat from an adjustment position placed close to the bottom completely downward along the vehicle device into an adjustment position adjusted completely upward along the vehicle vertical direction.

In principle, the proposed adjustment system can also have a control unit coupled with the at least one adjustment device, which is configured to activate the at least one adjustment device. In particular, the control unit can be configured to activate the at least one adjustment device to adjust the vehicle seat in reaction to a reception of an external signal. In this way, the adjustment system can be configured to adjust the vehicle seat in dependence on the external signal. As an example, the external signal can be a signal generated by a vehicle.

In particular, the external signal can be transmitted from the vehicle to the control unit when it is sensorially determined that the vehicle is connected to an external energy source. The proposed adjustment system can therefore be configured to automatically adjust a vehicle seat installed in the vehicle in reaction to the connection of the vehicle equipped with the adjustment system to an external energy source.

In particular, the proposed adjustment system can be configured to adjust the vehicle seat automatically into the quick charging position in reaction to the connection of the vehicle to an external energy source.

According to a further aspect of the proposed solution, the object mentioned at the outset is also achieved by a seat assembly for a vehicle having a vehicle seat mounted so it is adjustable along at least one adjustment direction and the proposed adjustment system. The vehicle seat is adjustable in a power-operated manner along the at least one adjustment direction via the at least one adjustment device of the adjustment system.

Due to the use of the proposed adjustment system, a proposed seat assembly is adjustable independently of a primary energy source of the vehicle, such as a vehicle electrical system. Furthermore, a material expenditure and therefore costs for conductor tracks which are necessary for the operation of the adjustment device of the adjustment system can be reducible.

As an example, the seat assembly can be configured to be adjusted by an adjustment within the vehicle into at least one charging position in which at least one coupling section of the at least one energy source-side conductor section is coupled with a coupling section of the at least one energy storage device-side conductor section to transmit energy. In this way, the at least one energy storage device of the proposed seat assembly can be rechargeable in the at least one charging position if needed.

In one embodiment of the proposed seat assembly, a large number of charging positions for charging the at least one energy storage device can be arranged in each adjustment position of the vehicle seat reachable along the at least one adjustment direction in a manner merging continuously one into another along the at least one adjustment direction. In this way, the at least one energy storage device can be chargeable, preferably continuously chargeable, independently of the adjustment position of the vehicle seat.

Furthermore, as an example, the proposed seat assembly can comprise a large number of charging positions of the vehicle seat. This can increase the usage convenience.

Furthermore, as an example, the proposed seat assembly can be configured having a plurality of coupling sections to charge the at least one energy storage device in each possible adjustment position within the vehicle interior. As an example, the energy source-side conductor section can have a plurality of adjacent coils for this purpose, which are configured to transmit energy wirelessly to at least one coupling section arranged on the at least one energy storage device-side conductor section. The at least one energy source-side section and the at least one energy storage device-side conductor section can therefore be able to be coupled with one another in each of the adjustment positions of the vehicle seat.

In a further exemplary embodiment, the vehicle seat of the proposed seat assembly can have a large number of charging positions which are configured to provide a first charging current for charging the at least one energy storage device. Furthermore, the seat assembly can have an energy source-side conductor section, which is configured to provide a second charging current. An amperage of the first charging current can be greater here than an amperage of the second charging current. Accordingly, the energy source-side conductor section for the higher charging current can be equipped with a coupling section which is also configured to transmit a stronger charging current than the at least one coupling section of the energy source-side conductor section for the second charging current.

As an example, the coupling section of the energy source-side conductor section for the first charging current can be configured to provide an electrically conductive connection to the at least one coupling section of the energy storage device-side conductor section. Furthermore, the at least one coupling section of the energy source-side conductor section for the second charging current can be configured for wireless energy transmission. Accordingly, the proposed seat assembly can be configured, in at least one charging position of the vehicle seat, to couple the energy storage device-side conductor section with the energy source-side conductor section via the direct electrical connection to provide the first charging current.

In a further embodiment of the proposed solution, the vehicle seat of the seat assembly can be designed having an upper rail arranged on the vehicle seat and a lower rail adjustably mounted on the upper rail. This can improve the adjustability of the vehicle seat.

As an example, the vehicle seat of the proposed seat assembly, in the state mounted as intended in the vehicle, can be adjustable via the at least one adjustment device in a power-operated manner along a seat longitudinal axis within the vehicle. In a further exemplary embodiment, the vehicle seat installed as intended can be adjustable via the at least one adjustment device in a power-operated manner along a vehicle transverse axis and/or the vehicle vertical direction.

Alternatively or additionally, a backrest inclination of the vehicle seat, a headrest adjustment, a seat heater, a massage, or the like can be operable via the proposed adjustment system.

In a further embodiment of the proposed solution, at least one of the coupling sections of one of the energy source-side conductor sections can be arranged on the lower rail and at least one of the coupling sections of one of the energy storage device-side conductor sections can be arranged on the upper rail.

Alternatively or additionally, the at least one coupling section of one of the energy source-side conductor sections can be configured to be arranged on a vehicle floor. Additionally, the at least one coupling section of the at least one storage device-side conductor section can be arrangeable on a vehicle seat.

In a further embodiment of the proposed solution, the at least one coupling section on the lower rail can be couplable with the at least one coupling section of the upper rail by adjusting the vehicle seat into a charging position. As an example, at least two of the coupling sections can be arranged spaced apart in relation to one another along the at least one adjustment direction on the lower rail. Furthermore, as an example, the at least one coupling section of the upper rail can be selectively able to be coupled with one of the at least two coupling sections of the lower rail. This can increase the usage convenience.

In a further embodiment of the proposed solution, the adjustment system can have a plurality of chargeable energy storage devices. Furthermore, the adjustment system can have a plurality of adjustment devices for adjusting the vehicle seat along a plurality of adjustment directions.

In a further embodiment of the proposed solution, one of the adjustment devices can be operable in each case via one of the plurality of energy storage devices. As an example, each of the energy storage devices can be adapted to the adjustment device operable thereby. An adaptation can comprise a capacitance and/or an operating current that can be provided. The proposed seat assembly can thus be adaptable via the plurality of energy storage devices and the plurality of the adjustment devices to various operating modes and/or operating situations. This can increase the operating convenience and reduce an energy storage capacity to be installed. As an example, an energy storage device for operating a comfort function such as a seat heater can be configured to provide a lower operating current than an energy storage device configured to operate an adjustment device of a seat longitudinal adjustment.

The preceding statements on the embodiments and advantages of the proposed adjustment system can also be applied analogously to the proposed seat assembly.

According to a further aspect of the proposed solution, the object mentioned at the outset is also achieved by a vehicle having at least one seat assembly according to the proposed solution. The adjustment system is connected to a vehicle electrical system of the vehicle to charge the at least one energy storage device.

In one possible embodiment, the plurality of the energy source-side coupling sections can be arranged spaced apart from one another on a vehicle floor below the seat assembly.

The preceding statements on the embodiments and advantages of the proposed seat assembly can also be applied analogously to the proposed vehicle.

According to a further aspect of the proposed solution, the object mentioned at the outset is also achieved by a method for adjusting a vehicle seat. The proposed method accordingly comprises:
providing an operating current for the motorized adjustment of an adjustment position of the vehicle seat using at least one electronically controllable adjustment device via at least one chargeable energy storage device, and
providing a charging current for charging the at least one energy storage device, wherein an amperage of the operating current is greater than the maximum amperage of the charging current.

Due to the operation of the at least one adjustment device via the at least one energy storage device, a charging device for charging the at least one energy storage device can be able to be designed for a lower amperage than a connection of the at least one energy storage device to the at least one adjustment device. Since moreover the at least one energy storage device and the at least one adjustment device are arranged on the vehicle seat in the state installed as intended, a cable length necessary for connecting the at least one energy storage device to the at least one adjustment device can be shorter than a cable length of the charging device. Using the proposed method, the connection between the at least one energy storage device and the at least one adjustment device can therefore be designed for the operating current occurring in operation, while in contrast the charging device can be designed for a lower amperage than that of the operating current, in particular only for a maximum amperage of the charging current occurring in operation. This can reduce a number of required cables and/or a diameter of the cables used for the charging device. Material expenditure, production costs, and weight can be reducible in this way.

Furthermore, due to the operation of the at least one adjustment device via the at least one energy storage device, the adjustment device can be adjustable at least temporarily independently of an external energy supply, in particular of a vehicle electrical system of a vehicle.

In a further embodiment of the proposed method, the vehicle seat can be adjustable in a motorized manner into at least one charging position, wherein the at least one energy storage device can be charged in the at least one charging position via an energy source connectable to the charging device, in particular a vehicle electrical system of a vehicle.

As an example, one of the charging positions can be a quick charging position, in which a provided charging current is greater than a charging current provided in one of the other charging positions. In this case, a duration for the charging of the at least one energy storage device in the quick charging position can be shorter than the duration for the charging in one of the other charging positions. As an example, the vehicle seat can be adjustable in a motorized manner between one of the remaining charging positions and the quick charging position.

In a further embodiment of the proposed method, the vehicle seat can be adjusted into a quick charging position in reaction to a quick charging signal. This can enable an automation of quick charging, by which the usage convenience can be increased.

As an example, an adjustment system configured for the method can have a control unit coupled with the at least one adjustment device, which is configured to receive the quick charging signal. In reaction to receiving the quick charging signal, the control unit can send an adjustment signal to adjust the vehicle seat to the at least one adjustment device. In this way, the vehicle seat can be adjustable into the quick charging position in reaction to the quick charging signal.

In a further exemplary embodiment, the quick charging signal can be received by the at least one adjustment device, wherein it adjusts the vehicle seat in reaction to the quick charging signal.

As an example, a vehicle configured with the proposed adjustment system for the proposed method can sensorially detect a quick charging event and generate the quick charging signal in reaction to such a detection. The vehicle can be configured to send the quick charging signal to the control unit or the at least one adjustment device.

As an example, the vehicle can generate the quick charging signal when a vehicle electrical system of the vehicle is connected to an external electrical energy source. In particular with regard to electrically driven vehicles, a quick charging signal can thus be generated when the vehicle is connected for charging to an external electrical energy source. In this way, the at least one energy storage device of the proposed adjustment system can be adjusted into the quick charging position and charged in an automated manner. In this way, energy required for the charging of the at least one energy storage device outside the vehicle charging times can be reduced. This can preserve the vehicle electrical system, in particular a vehicle battery, and increase the usage convenience.

In a further embodiment of the proposed method, the vehicle seat can be adjusted into the quick charging position in reaction to a determination that the vehicle seat is unused. In this way, it can be avoidable that persons, objects, or animals are trapped by an automated adjustment of the vehicle seat.

As an example, a vehicle configured with the proposed adjustment system for the proposed method can sensorially detect whether the vehicle seat is used or unused. In particular, used can mean that a person, an object, or an animal is placed on the vehicle seat. Furthermore, the vehicle seat can also be identified as used if a person, an object, or an animal is located in an adjustment path of the vehicle seat. In particular, the vehicle seat can also furthermore be identified as used if a person, an object, or an animal could be trapped by the adjustment of the vehicle seat into the quick charging position. The vehicle can be configured to generate a usage signal and send it to the control unit or the at least one adjustment device. The control unit or the adjustment device can be configured to block the adjustment of the vehicle seat into the quick charging position when the usage signal is received. In particular, the control unit or the adjustment device can be configured to block the adjustment of the vehicle seat into the quick charging position in reaction to the usage signal even if the quick charging signal is additionally received.

The preceding statements on the embodiments and advantages of the proposed adjustment system are also applicable analogously to the proposed vehicle.

Furthermore, the object mentioned at the outset is also achieved by a computer program product for an adjustment system configured for adjusting a vehicle seat. The proposed computer program product has instructions which prompt at least one processor of an electronic control unit of the adjustment system to carry out the proposed method upon execution of the instructions.

The preceding statements on the embodiments and advantages of the proposed method are also applicable analogously to the proposed computer program product.

The solution furthermore relates to a kit for producing an adjustment system as described herein and/or claimed hereinafter, comprising multiple different energy storage devices and at least two adjustment devices, which are assigned to one another according to their power classes.

### BRIEF DESCRIPTION OF THE DRAWINGS

The appended figures show possible exemplary embodiments of the proposed solution. Individual aspects of the illustrated exemplary embodiments can also be combinable with one another.

FIG. 1 shows an adjustment system for a vehicle seat with an electronically controllable adjustment device, a chargeable energy storage device, and a charging device.

FIG. 2 shows a further adjustment system with two energy storage devices, two adjustment devices, and a charging device having a plurality of coupling sections for the wireless transmission of energy.

FIG. 3 shows a further adjustment system, wherein the charging device has two coupling sections to establish an electrically conductive connection.

FIGS. 4, 5 show two exemplary flow charts of a method for adjusting a vehicle seat.

### DETAILED DESCRIPTION

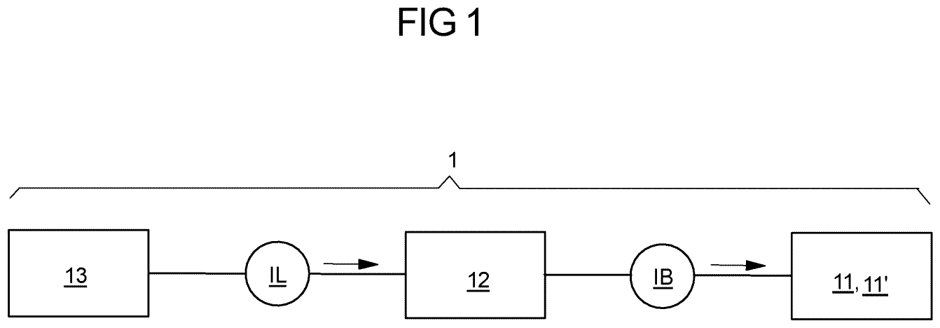

FIG. 1 shows a first embodiment of the proposed adjustment system 1 for a vehicle seat 2 according to the proposed solution. The adjustment system 1 comprises an electronically controllable adjustment device 11, 11′ for the motorized adjustment of an adjustment position of the vehicle seat 2. A chargeable energy storage device 12, 12′, which is configured to provide an operating current IB for operation of the adjustment device 11, 11′, is electrically connected to the adjustment device 11, 11′. To charge the energy storage device 12, 12′, a charging device 13 is connected to the energy storage device 12, 12′ and is connectable to an energy source 3 (not shown). The charging device 13 is configured to provide a charging current IL, wherein an amperage of the operating current IB is greater than a maximum amperage of the charging current IL.

In an alternative embodiment deviating from the embodiment shown, the charging device 13 can have at least two conductor sections, which can be coupled with one another, for transmitting electrical energy from the energy source 3 to the energy storage device 12, 12′.

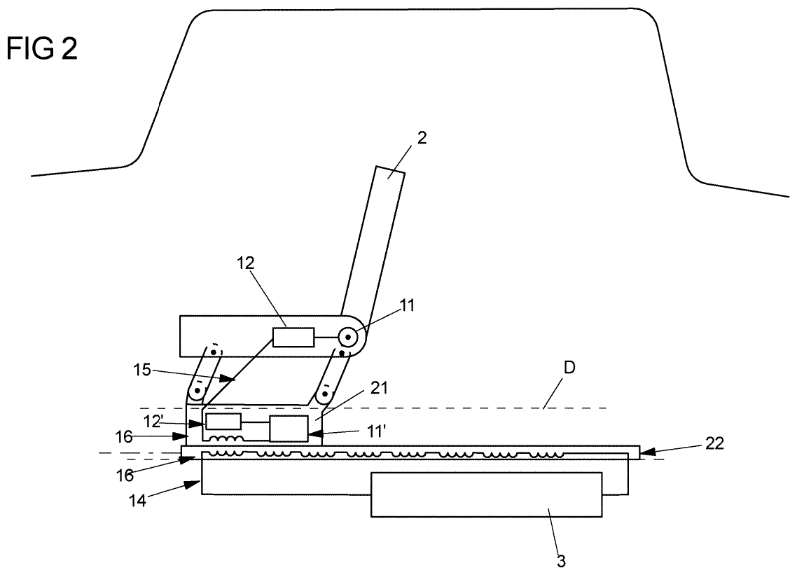

For this purpose, FIG. 2 shows a further embodiment of the proposed adjustment system 1, wherein the charging device 13 has an energy source-side conductor section 14 connected to an energy source 3 and an energy storage device-side conductor section 15 connected to two energy storage devices 12, 12′. The energy source-side conductor section 14 has a plurality of coupling sections 16 spaced apart from one another, which are configured to transmit electrical energy wirelessly. The coupling sections 16 of the energy source-side conductor section 14 are formed having coils for this purpose. The coils are arranged adjacent to one another along a vehicle longitudinal axis D below the vehicle seat 2 in the area of a vehicle floor. The energy storage device-side conductor section has precisely one coupling section 16, which is also formed having a coil. In this way, the coupling section 16 of the energy storage device-side conductor section 15 is configured to receive electrical energy wirelessly. A coupling of one of the coupling sections 16 of the energy source-side conductor section 14 at a time with the coupling section 16 of the energy storage device-side conductor section 15 is producible by a spatial proximity of the coupling sections 16. The coupling sections 16 of the energy source-side conductor section 14 are thus configured to each build up an electromagnetic field by a current supply via the energy source 3. If the coupling section 16 of the energy storage device-side conductor section 15 is arranged in spatial proximity to one of the coupling sections 16 of the energy source-side conductor section 14, the charging current IL is induced in the coupling section 16 of the energy storage device-side conductor section 15. Due to the induction of the charging current IL in the energy storage device-side conductor section 15, the two chargeable energy storage devices 12, 12′ of the adjustment system 1 can be charged using the charging device 13. For this purpose, the vehicle seat 2 can be coupled by an adjustment along the vehicle longitudinal axis D with each of the illustrated coupling sections 16 of the energy source-side conductor section 14.

The energy storage devices 12, 12′ are each connected to one of the adjustment devices 11, 11′, in order to adjust the adjustment position of the vehicle seat 2 in a power-operated manner via the adjustment devices 11, 11′. The upper one of the energy storage devices 12 shown in FIG. 2 is connected to an adjustment device 11 for adjusting an inclination of the seat rest. The lower of the illustrated energy storage devices 12′ is connected to an adjustment device 11′ for adjusting the vehicle seat 2 along the vehicle longitudinal axis D.

In an embodiment of the coupling sections 16 deviating from the embodiment shown, they can be configured for wireless energy transmission by resonant inductive energy transmission, by capacitive or by directed electromagnetic waves. As an example, the coupling sections 16 can be formed for this purpose having capacitors, having a laser and a photocell, and/or a directed radio antenna.

In a further alternative embodiment, at least one of the coupling sections 16′ of the at least one energy source-side conductor section 14 and at least one of the coupling sections 16′ of the at least one energy storage device-side conductor section 15 can be detachably electrically conductively connectable to one another.

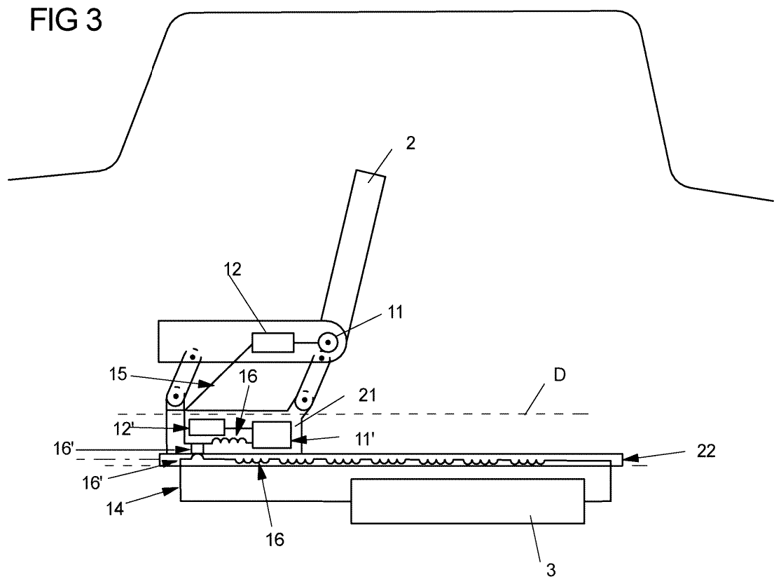

For this purpose, FIG. 3 shows a further embodiment of the proposed adjustment system 1, wherein in each case one of the coupling sections 16′ of the energy storage device-side conductor section 15 and the energy source-side conductor section 14 are detachably electrically conductively connected to one another in the illustrated charging position. As an example, the coupling sections 16′ for the detachable electrically conductive connection can have at least one spring-loaded conductive contact pin, which supports itself in the coupled position on an electrically conductive contact surface of another coupling section 16′. The current transmittable via the coupling sections 16′ electrically conductively connected in this way can be greater than the charging current IL transmittable via the coupling sections 16′ for wireless energy transmission.

In an embodiment deviating from the illustrated embodiment, a conductor cross section of the charging device 13 can be smaller at least one location than a minimal conductor cross section of the connection of the at least one energy storage device 12, 12′ to the at least one adjustment device 11, 11′. Furthermore, the charging device 13 can have a charging electronics unit for monitoring a state of charge of the at least one energy storage device 12, 12′ and for regulating the charging current IL. As an example, such a charging electronics unit can be configured to regulate the charging current IL for each of the energy storage devices 12, 12′ between a value of 0 A and the maximum charging current in dependence on the state of charge of the respective energy storage device 12, 12′.

In a further alternative embodiment, the proposed adjustment system 1 can in principle comprise an arbitrary number of chargeable energy storage devices 12, 12′ and an arbitrary number of adjustment devices 11, 11′. Each of the adjustment devices 11, 11′ can be configured here for the power-operated adjustment of the vehicle seat 2.

In a further embodiment deviating from the illustrated embodiment, the charging device 13 can have a plurality of energy source-side conductor sections 14 and a plurality of energy storage device-side conductor sections 15. In particular, the charging device 13 can have a first conductor section on the energy source side having the at least one coupling section 16′ for the detachable electrically conductive connection and a second energy source-side conductor section having the at least one coupling section 16 for wireless energy transmission. The first conductor section can be configured here to provide a higher charging current IL than the second energy source-side conductor section 14. In the intended operation, it is possible to switch selectively between a higher or lower charging current IL via the coupling of the energy storage device-side conductor section 15 with the first or the second energy source-side conductor section.

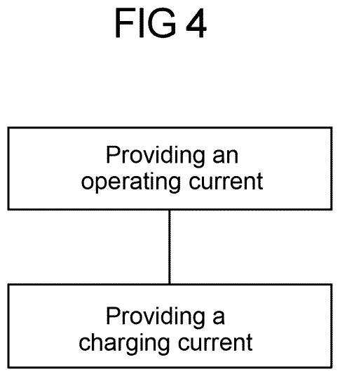

FIG. 4 shows a first possible sequence of a proposed method for adjusting a vehicle seat 2. Accordingly, the proposed method comprises providing an operating current IB for the motorized adjustment of an adjustment position of the vehicle seat 2 using at least one electronically controllable adjustment device 11, 11′ via at least one chargeable energy storage device 12, 12′. Furthermore, the method comprises providing a charging current IL for charging the at least one energy storage device 12, 12′. In this case, an amperage of the operating current IB is greater than the maximum amperage of the charging current IL.

The illustrated sequence does not imply a chronological order of the individual method steps. It is thus conceivable and possible in principle to provide the charging current IL chronologically before and/or during and/or after providing the operating current IB.

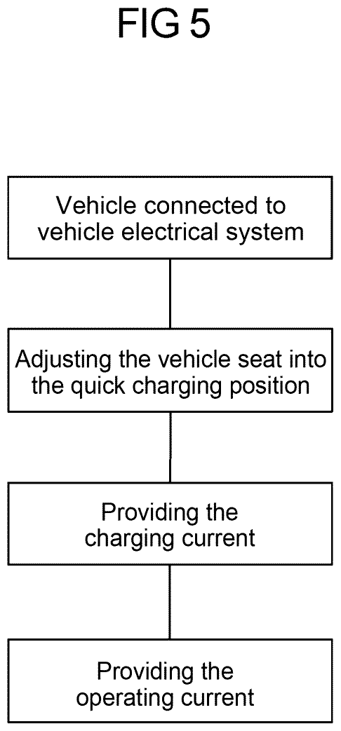

FIG. 5 shows a further possible sequence of the proposed method. In this case, a vehicle seat 2 installed in the vehicle is adjusted into a quick charging position in reaction to a vehicle configured with the proposed adjustment system 1 for the proposed method being connected to a vehicle electrical system. In this position, a charging device 13 of the adjustment system 1 can be charged via a charging current IL. The charging current IL in the quick charging position is higher than a charging current IL provided in further charging positions of the vehicle seat 2. The operating current IB for the at least one adjustment device 11, 11′ is provided using the at least one at least partially charged energy storage device 12, 12′ of the adjustment system 1.

In this illustration as well, the provision of the charging current IL chronologically before and/or during and/or after the provision of the charging current IB is conceivable and possible in principle, provided the at least one energy storage device 12, 12′ is at least partially charged.

### LIST OF REFERENCE SIGNS

1 adjustment system
11, 11′ adjustment device
12, 12′ energy storage device
13 charging device
14 energy source-side conductor section
15 energy storage device-side conductor section
16, 16′ coupling section
IB operating current
IL charging current
2 vehicle seat
21 upper rail
22 lower rail
3 energy source
D vehicle longitudinal axis

1. An adjustment system for a vehicle seat, comprising
at least one electronically controllable adjustment device for the motorized adjustment of an adjustment position of the vehicle seat,
at least one chargeable energy storage device, which is electrically connected to the at least one adjustment device and is configured to provide an operating current for operating the at least one adjustment device, and
a charging device, which is connected or connectable to the at least one energy storage device and is connectable to an energy source to charge the at least one energy storage device and is configured to provide a charging current, wherein an amperage of the operating current is greater than a maximum amperage of the charging current.

2. The adjustment system as claimed in claim 1, wherein at least one of
the charging device has a lower current carrying capacity than a connection of the at least one energy storage device to the at least one adjustment device and
the charging device has at least one energy source-side conductor section connectable to the energy source and at least one energy storage device-side conductor section, which is connected to the at least one energy storage device and can be detachably coupled with the at least one energy source-side conductor section, for transmitting electrical energy.

3. The adjustment system as claimed in claim 1, wherein a quotient of the operating current and a minimal conductor cross section of the charging device is greater than a melting current density of the charging device at the location of the minimal conductor cross section.

4. (canceled)

5. (canceled)

6. The adjustment system as claimed in claim 1, wherein the adjustment system enables at least two coupling positions, in particular enables multiple coupling positions arranged in series in the longitudinal direction, in each of which a coupling of the energy source-side conductor section with the energy storage device-side conductor section is configured or configurable.

7. The adjustment system as claimed in claim 1, wherein at least two of the coupling sections are arranged spatially separated from one another on one of the at least one energy source-side conductor sections.

8. The adjustment system as claimed in claim 1, wherein the at least one energy storage device-side conductor section can selectively be coupled with one of the at least two coupling sections spatially separated from one another.

9. The adjustment system as claimed in claim 1, wherein each adjustment position of the vehicle seat, a coupling of the energy source-side conductor section with the energy storage device-side conductor section is configured or configurable.

10. The adjustment system as claimed in claim 1, wherein in at least one of
at least one of the coupling sections of the at least one energy source-side conductor section and at least one of the coupling sections of the at least one energy storage device-side conductor section are configured for wireless energy transmission via an electromagnetic field and
at least one of the coupling sections of the at least one energy source-side conductor section and at least one of the coupling sections of the at least one energy storage device-side conductor section are detachably electrically conductively connectable to one another.

11. (canceled)

12. The adjustment system as claimed in claim 1, wherein the charging device has a first energy source-side conductor section having the at least one coupling section for the detachable electrically conductive connection and a second energy source-side conductor section having the at least one coupling section for the wireless energy transmission.

13. The adjustment system as claimed in claim 1, wherein the first energy source-side conductor section has a higher current carrying capacity than the second energy source-side conductor section.

14. The adjustment system as claimed in claim 1, wherein at least one of
the adjustment system is designed so that no redundant power supply of the adjustment device via the charging device and the at least one energy storage device is provided and
the adjustment system has at least two energy storage devices, in particular has energy storage devices independent of one another, which are each electrically connected or connectable to the charging device, and wherein the adjustment system has at least two adjustment devices for the motorized adjustment of an adjustment position of the vehicle seat, preferably wherein each adjustment device has at least one energy storage device assigned thereto, which is exclusively configured for the power supply of the adjustment device assigned thereto.

15. (canceled)

16. The adjustment system as claimed in claim 1, wherein at least one of
the energy storage devices assigned to the different adjustment devices have different power classes and
a charging of one of the at least two energy storage devices via the charging device is at least one of activatable and deactivatable independently of another of the at least two energy storage devices.

17. (canceled)

18. The adjustment system as claimed in claim 1, wherein at least one of
the adjustment system has a checking unit, which is configured for checking the state of charge of the at least one energy storage device, wherein the checking unit emits a warning signal as soon as the state of charge is below a critical state of charge value, in particular wherein the warning signal is transmittable to a control unit of a vehicle and/or is displayable via a display device to a user,
a contactless and a contact-based current transmission is possible via the charging device, in particular wherein in the normal case a contactless current transmission takes place and in the quick charging case a contact-based current transmission takes place, and
a charging voltage generated by an energy source is different from an operating voltage required for operating the at least one adjustment device.

19. (canceled)

20. (canceled)

21. The adjustment system as claimed in claim 1, wherein at least one of
the at least one electronically controllable adjustment device comprises at least one seat longitudinal adjustment and
the charging device is deactivatable, wherein the at least one electronically controllable adjustment device can be supplied with current independently via the at least one energy storage device when the charging device is deactivated.

22. (canceled)

23. The adjustment system as claimed in claim 1, wherein the adjustment system has a control device, which is configured to deactivate a charging of the at least one energy storage device if the state of charge of the energy source is below a threshold value, preferably wherein the control device is configured to deactivate the charging device as soon as the state of charge of the energy source is below a threshold value.

24. A seat assembly for a vehicle having a vehicle seat mounted so it is adjustable along at least one adjustment direction and having an adjustment system as claimed in claim 1, wherein the vehicle seat is adjustable in a power-operated manner along the at least one adjustment direction via the at least one adjustment device of the adjustment system.

25. The seat assembly as claimed in claim 24, wherein the vehicle seat is formed having an upper rail arranged on the vehicle seat and a lower rail adjustably mounted on the upper rail.

26. (canceled)

27. The seat assembly as claimed in claim 24, wherein the at least one coupling section of the at least one energy source-side conductor section and the at least one coupling section of the at least one energy storage device-side conductor section can be coupled with one another by adjusting the vehicle seat into at least one charging position.

28. (canceled)

29. A method for adjusting a vehicle seat, comprising
providing an operating current for the motorized adjustment of an adjustment position of the vehicle seat using at least one electronically controllable adjustment device via at least one chargeable energy storage device, and
providing a charging current for charging the at least one energy storage device, wherein an amperage of the operating current is greater than the maximum amperage of the charging current.

30. The method as claimed in claim 29, wherein the vehicle seat is adjustable in a motorized manner between a charging position and a quick charging position, wherein a charging current provided in the quick charging position is greater than a charging current provided in the charging position.

31. (canceled)

32. (canceled)

33. (canceled)
